(19) United States
(12) Patent Application Publication
(10) Pub. No.: US 2026/0067110 A1
(43) Pub. Date: Mar. 5, 2026

(54) IDLE POWER SAVING

(71) Applicant: MELLANOX TECHNOLOGIES, LTD., Yokneam (IL)

(72) Inventors: Guy Lederman, Ness Ziona (IL); Asaf Horev, Ramat Gan (IL); Ran Ravid, Tel Aviv (IL)

(21) Appl. No.: 18/821,072

(22) Filed: Aug. 30, 2024

(51) Int. Cl. H04L 12/12; H04W 52/02

(52) U.S. Cl. CPC H04L 12/12; H04W 52/02

(57) ABSTRACT

A device or system including one or more devices is provided. In one example, a device includes one or more circuits that enable the device to determine that a communication link between a first communication node and a second communication node is in a link idle state. The device may further, in response to determining that the communication link is in the link idle state, transmit a disable command to one or both of the first communication node and the second communication node, where the disable command causes a recipient thereof to disable part of an encoding operation for the communication link.

### FIELD OF THE DISCLOSURE

The present disclosure is generally directed toward networking and, in particular, toward networking devices and methods of improving power consumption for the same.

### BACKGROUND

Switches and similar network devices represent a core component of many communication, security, and computing networks. Switches are often used to connect multiple devices, device types, networks, and network types.

Devices including but not limited to personal computers, servers, or other types of computing devices, may be interconnected using network devices such as switches. Such interconnected entities form a network that enables data communication and resource sharing among the nodes. While a particular switch may be capable of handling large amounts of data, often, switches do not operate at full capacity and communication links between nodes may transition into and out of low-traffic states. As a result, conventional switches and nodes consume amounts of power which may be unnecessarily high, especially during periods of low traffic.

### BRIEF SUMMARY

There has been an explosion in the amount of data that computers need to maintain and process. Social media, artificial intelligence, and the Internet of Things have all created needs to store and quickly process vast amounts of data.

The trend in modern computing has been to deploy high performance, massively parallel processing systems, thus breaking up large computation tasks into many smaller ones that can be performed concurrently. As such parallel processing architectures have become widely adopted, this has in turn created demand for large capacity, high performance, low latency memory that can store large amounts of data and provide parallel processors with quick access.

Additionally, even though modern system memory capacity might seem relatively abundant, some massively parallel processing systems are now pushing the envelope in terms of memory capacity. System memory capacity is generally limited based on the maximum address space of whatever CPU(s) is employed. For example, many modern CPUs are unable to access more than approximately three terabytes (TBs). This capacity (three million bytes) may sound like a lot but may not be enough for certain massively parallel GPU operations such as deep learning, data analytics, medical imaging, and graphics processing.

Data centers and other computing environments, such as those employing artificial intelligence (AI) training systems, use a network infrastructure, which may be referred to as a fabric, which provides interconnectivity between various components, facilitating rapid data transfer and communication for handling large volumes of data and computationally intensive tasks. Such computing environments may utilize a fabric of processing devices such as GPUs and switches to provide computing capabilities for hosts devices such as personal computers and servers.

In such computing environments there may be periods of time during which portions of the fabric are idle or partially idle in terms of traffic. For example, switches may be used in bursts to provide interconnectivity to GPUs and may remain idle or partially idle as the GPUs perform computing functions. Conventionally, a significant amount of power is wasted in such scenarios.

Some power-saving features have been developed to save power when the communication link between two nodes is idle for a long period of time by powering the PHY components of the partner nodes connected to the communication link. Such power-saving approaches are referred to as L1 power saving approaches. L1 power saving is significant but suffers long entry and exit latencies. Embodiments of the present disclosure aim to improve power performance of devices in a network (e.g., switches, nodes, computing devices, etc.) in a way that minimizes entry and exit latencies. For instance, the power saving approach(es) depicted and described herein may provide power saving for devices with entry and exit latencies on the order of 1 us or less compared to previous power saving approaches that could have entry and exit latencies on the order of 100 us.

The present disclosure describes a system and method for enabling a device, such as a switch, or other computing system to improve power performance (e.g., power performance associated with devices in a data center or the like) by disabling encoder/decoder logic (e.g., a Forward Error Correction (FEC) encoder and/or FEC decoder). During a link idle period (e.g., when no packets are being transmitted), requirements associated with the communication link are decreased. For instance, the importance of maintaining a secure communication link is decreased when no packets are being transmitted across the communication link. Using this assumption, embodiments of the present disclosure aim to conserve power by disabling the FEC encoder and/or FEC decoder functionality of the link partners (e.g., nodes connected to the communication link). To achieve this power saving, a flow is defined to synchronize both link partners to prevent false error indications.

According to at least some embodiments of the present disclosure, a controller may be provided with the capability of deciding when a communication link should enter an idle state (e.g., an L0 IDLE state). Once the communication link has entered the idle state, the partner nodes associated with the communication link may be requested to carry out power-saving measures. For instance, the partner nodes may be requested to have their internal controllers implement one or more power-saving functions. Embodiments of the present disclosure contemplate instructing one or both partner nodes of a communication link to synchronize with one another and save power by disabling some or all of their respective encoder and decoder functionalities. In some embodiments, the partner nodes may be requested to save Forward Error Correction (FEC) encoder and FEC decoder power while also synchronizing both size of the communication link that has been determined to be in a link idle state.

In some embodiments, the flow across the communication link (e.g., between the partner nodes) may be unidirectional. In such a situation, the entity coordinating the power consumption of the partner nodes associated with the communication link may instruct the transmitter node to enter an IDLE state. Upon receiving such an instruction, the transmitter node may ensure that all pending traffic has been sent (e.g., the communication link is ensured to be empty and without additional packets traversing the same). Once the communication link is determined to be empty, the transmitter node may send a command to the other partner node (e.g., the receiving node), which causes the receiving node to disable its FEC decoder functionality. In some embodiments, the command transmitted from the transmitter node to the receiving node may include an indication of a number of FEC blocks that the receiving node should consume before disabling its FEC decoder. At the same time (e.g., after transmitting the command to the receiving node), the transmitter node may disable its own FEC encoder. When both partner nodes have disabled their respective FEC encoder and FEC decoder functionality, the communication link may be considered to have entered an L0 IDLE state.

When either of the partner nodes desire to exit the L0 IDLE state, the desirous node may send a command to its partner node. In a scenario of a unidirectional communication link, the transmitter node may send a command to the receiving node indicating that the transmitter node desires to exit the L0 IDLE state and that the receiving node should enable its FEC decoder functionality within a predetermined number of FEC blocks. Upon receiving the command from the transmitter node, the receiving node may count the number of blocks received from the transmitter node over the communication link until the predetermined number of FEC blocks (e.g., “X” blocks) have been received, after which point the receiving node may enable its FEC decoder. Simultaneously (e.g., after the transmitter node has sent the command to exist the L0 IDLE state), the transmitter node may enable its own FEC encoder functionality.

After both partner nodes have enabled their respective FEC encoder and FEC decoder functionality, traffic on the communication link is again protected and packets can be sent across the communication link in a secured fashion.

To support the sharing of control information between the two link partners, a predetermined header (e.g., a vendor specific header) may be used to communicate over the communication link, even when the FEC encoder and FEC decoder functionality of the link partners has been disabled. The vendor specific header may still be protected in the absence of being encoded by the transmitter node. This security functionality provided by the vendor specific header can be achieved by enabling the encoder/decoder only for the control info which consumes a negligible part of the encoder and decoder power.

In an illustrative example, a device is disclosed that includes one or more circuits to: determine that a communication link between a first communication node and a second communication node is in a link idle state; and in response to determining that the communication link is in the link idle state, transmit a disable command to one or both of the first communication node and the second communication node, where the disable command causes a recipient thereof to disable part of an encoding operation for the communication link.

According to at least some aspects, the communication link is determined to be in the link idle state in response to receiving a state update from a power management controller.

According to at least some aspects, the first communication node includes a transmitter node, the second communication node include a receiver node, and communications between the first communication node and the second communication node are unidirectional.

According to at least some aspects, the transmitter node transmits the disable command to the receiver node in response to the transmitter node determining that the communication link is in the link idle state.

According to at least some aspects, the one or more circuits are further to: determine all pending traffic between the first communication node and the second communication node has been transmitted such that the communication link is empty; and after determining that the communication link is in the link idle state and is empty, transmit the disable command from the transmitter node to the receiver node.

According to at least some aspects, the part of the encoding operation includes an error correction decoding.

According to at least some aspects, the encoding operation includes at least one of a Forward Error Correction (FEC) coding and a FEC decoding.

According to at least some aspects, the part of the encoding operation includes an error correction encoding.

According to at least some aspects, the one or more circuits are further to: determine the communication link is transitioning out of the link idle state; and in response to determining that the communication link is transitioning out of the link idle state, transmit an enable command to one or both of the first communication node and the second communication node, where the enable command causes the recipient thereof to enable the part of the encoding operation for the communication link that was discontinued in response to receiving the disable command.

According to at least some aspects, the enable command specifies a number of blocks that will be transmitted prior to enabling the encoding operation for the communication link.

According to at least some aspects, the communication link remains in an active state even while the part of the encoding operation is disabled.

According to at least some aspects, the disable command is included in an inband communication between both sides of the communication link.

According to at least some aspects, the communication link is maintained as an error free link while in the link idle state.

In accordance with at least some embodiments, a communication node is provided that includes: a port that facilitates interconnectivity with a communication network; and one or more circuits to: establish a communication link with a receiver node via the port; determine that the communication link is in a link idle state; and in response to determining that the communication link is in the link idle state, transmit a disable command to the receiver node, where the disable command causes the receiver node to disable a decoding operation for the communication link.

According to at least some aspects, the communication link is determined to be in the link idle state in response to receiving a state update from a power management controller.

According to at least some aspects, the one or more circuits are further to: determine all pending traffic for the receiver node has been transmitted such that the communication link is empty; and after determining that the communication link is in the link idle state and is empty, transmit the disable command to the receiver node.

According to at least some aspects, the decoding operation includes an error correction decoding.

According to at least some aspects, the one or more circuits are further to: determine the communication link is transitioning out of the link idle state; and in response to determining that the communication link is transitioning out of the link idle state, transmit an enable command to the receiver node that causes the receiver node to enable the decoding operation.

According to at least some aspects, the enable command specifies a number of blocks that will be transmitted prior to enabling an encoding operation for the communication link.

In accordance with at least some embodiments, a communication node is provided that includes: a port that facilitates interconnectivity with a communication network; and one or more circuits to: establish a communication link with a transmitter node via the port; receive, via the port, a disable command indicating that the communication link is in a link idle state; and in response to receiving the disable command, disable a decoding operation for the communication link.

According to at least some aspects, the communication link remains in an active state even while the decoding operation is disabled, and the communication link is unidirectional.

Additional features and advantages are described herein and will be apparent from the following Detailed Description and the figures.

### BRIEF DESCRIPTION OF THE SEVERAL VIEWS OF THE DRAWINGS

The present disclosure is described in conjunction with the appended figures, which are not necessarily drawn to scale:

FIG. 1 is a block diagram depicting an illustrative configuration of a network in accordance with at least some embodiments of the present disclosure;

FIG. 2 is a block diagram depicting an illustrative configuration of a device in accordance with at least some embodiments of the present disclosure;

FIG. 3 is a block diagram depicting an illustrative configuration of routing circuitry in accordance with at least some embodiments of the present disclosure;

FIG. 4 is a block diagram depicting contents of memory in accordance with at least some embodiments of the present disclosure;

FIG. 5 is a flowchart depicting a first method in accordance with at least some embodiments of the present disclosure;

FIG. 6 is a flowchart depicting a second method in accordance with at least some embodiments of the present disclosure;

FIG. 7 is a flowchart depicting a third method in accordance with at least some embodiments of the present disclosure; and

FIG. 8 is a state diagram illustrating possible states of a transmitter node in accordance with at least some embodiments of the present disclosure.

Like reference numbers and designations in the various drawings indicate like elements.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not to be deemed “material. ”

The terms “determine,” “calculate,” and “compute,” and variations thereof, as used herein, are used interchangeably, and include any appropriate type of methodology, process, operation, or technique.

Various aspects of the present disclosure will be described herein with reference to drawings that are schematic illustrations of idealized configurations. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

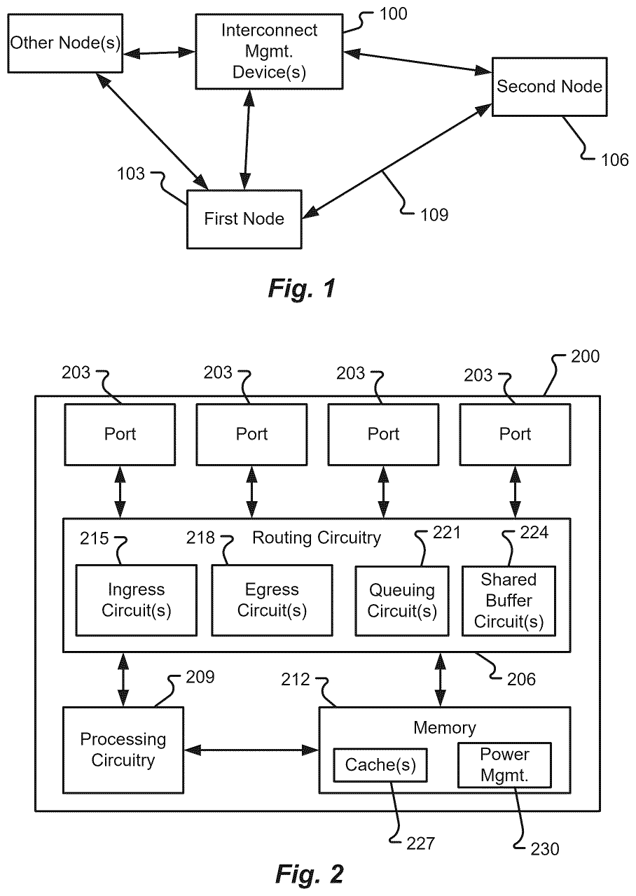

Referring now to FIGS. 1-8, various systems and methods for implementing a power saving process will be described. According to at least some embodiments of the present disclosure, a power saving can be realized by disabling at least part of a node's encoding and/or decoding functionality when the node is associated with a communication link found to be in a link idle state. While the encoding and/or decoding functionality is disabled, a flow can be utilized to synchronize both link partners associated with the communication link, thereby preventing false error indications.

Referring initially to FIG. 1, a computing environment as described herein may be a network of devices which may be interconnected directly (e.g., by a cable) or indirectly (e.g., by a fabric). A fabric as described herein may include one or more interconnect devices and/or one or more processing devices. The computing environment may include interconnect devices, computing devices, client devices, switches, servers, CPUs, GPUs, communication nodes, or the like. Illustratively, and without limitation, the computing environment may include one or more devices in a data center. For instance, the computing environment may include a plurality (N) of GPUs that communicate with one another via a high-performance high-bandwidth interconnect fabric such as NVIDIA's NVLINK™ as one example. Other systems may provide a single GPU that is connected to NVLINK™.

The NVLINK™ interconnect fabric (which includes communication links 109, nodes 103, 106, interconnect management devices 100, and other devices, may provide multiple high-speed links connecting nodes 103, 106 in the form of GPUs. In the example shown, each node in the computing environment may be connected with at least one other node via one or more high-speed communication links 109. Thus, a first node 103 may connect with a second node 106 via a first communication link 109 and may be further connected to other nodes as well as the interconnect management device 100 via other communication links. It should be appreciated that some GPUs can connect directly with other GPUs without interconnecting through interconnect management device 100.

In the example embodiment shown, each node 103, 106 can use high-speed links 109 and/or the interconnect management device 100 to communicate with the memory provided by any or all of the other nodes. For example, there may be instances and applications in which nodes are provided in the form of a GPU and each GPU requires more memory than is provided by its own locally attached memory. As some non-limiting use cases, when system 100 is performing deep learning training of large models using network activation offload, analyzing “big data” (e.g., RAPIDS analytics (ETL), in-memory database analytics, graph analytics, etc.), computational pathology using deep learning, medical imaging, graphics rendering or the like, it may require more memory than is available as part of each GPU.

As one possible solution, each GPU can use links 109 and other devices (e.g., a switch) to access memory local to any other GPU as if it were the GPU's own local memory. Thus, each GPU may be provided with its own locally attached memory that it can access without initiating transactions over the interconnect fabric but may also use the interconnect fabric to address/access individual words of the local memory of other GPUs interconnected to the fabric. In some non-limiting embodiments, each GPU is able to access such local memory of other GPUs using MMU hardware-accelerated atomic functions that read a memory location, modify the read value and write the results back to the memory location without requiring load-to-register and store-from-register commands (see above).

Such access by one GPU of the local memory of another GPU may be “the same” (although not quite as fast), from the perspective of an application executing on the GPU originating the access, as if the GPU were accessing its own locally attached memory. Hardware within each GPU and hardware within a switch provides necessary address translations to map virtual addresses used by the executing application into physical memory addresses of the GPU's own local memory and the local memory of one or more other GPUs. As explained herein, such peer-to-peer access is extended to fabric attached memory without the concomitant expense of adding further compute-capable GPUs.

The nodes 103, 106 and other nodes may correspond to computational devices, communication devices, interconnect devices, or the like. The interconnect management device(s) 110 may also correspond to a computational device, communication device, or interconnect device. In some embodiments, the nodes 103, 106 may communicate directly with one another via a communication link 109. In some embodiments, a communication link between the first node 103 and second node 106 may correspond to an indirect communication link, meaning that the communication link passes through one or more interconnect devices. In either scenario, the interconnect management device 100 may be configured to monitor a status of the communication link established between the first node 103 and second node 106. When the first node 103 and second node 106 are in communication with one another via a communication link, the first node 103 and second node 106 may be considered link partners or partner nodes.

The one or more interconnect devices and interconnect management device(s) 100 may be in communication with the nodes 103, 106 either directly or indirectly. Such a network of computing devices may be useful in various settings, from data centers and cloud computing infrastructures to AI systems.

As noted above, the first node 103 and/or second node 106 may be computing units, such as personal computers, servers, or other computing devices, and may be responsible for executing applications and performing data processing tasks. Nodes 103, 106 as described herein can range from servers in a data center to desktop computers in a network, or to devices such as internet of things (IoT) sensors and smart devices. Nodes may also include processing devices which may include one or more processing circuits, such as GPUs, central processing units (CPUs), application-specific integrated circuits (ASICs), field programmable gate arrays (FPGAs), or other circuitry capable of performing computations, as well as memory and storage resources to run software applications, handle data processing, and perform specific tasks as required. In some implementations, nodes 103, 106 may also or alternatively include hardware such as GPUs for handling intensive tasks for machine learning, artificial intelligence (AI) workloads, or other complex processes.

For example, nodes 103, 106 may operate as a high-performance computing (HPC) cluster. A cluster of nodes 103, 106 provided as multiple processing devices may comprise numerous interconnected servers, each equipped with powerful CPUs and/or GPUs. The processing devices may provide computational horsepower for, as an example, training large-scale AI models or running complex scientific simulations. For AI and machine learning tasks, the processing devices may comprise one or more GPUs or other processing circuitry which may be capable of handling parallel processing requirements of neural networks and other applications.

Interconnect devices and interconnect management devices 100 may enable communication between nodes 103, 106, either directly or indirectly. An interconnect device or interconnect management device 100 may be, for example, a switch, a network interface controller (NIC), or other device capable of receiving and sending data, and may act as a central node in the network. Interconnect devices may be wired in a topology including spine switches and top-of-rack (TOR) switches for example. Interconnect devices may be capable of receiving, processing, and forwarding data, e.g., packets, to appropriate destinations within the network, such as nodes 103, 106. In some implementations, an interconnect device or interconnect management device as described herein may be included in a switch box, a platform, or a case which may contain one or more interconnect devices 100 as well as one or more power supply devices.

In some implementations, each node 103, 106 may be connected to one or more ports of one or more interconnect devices via network cables or wirelessly. Processes, such as applications, executed by nodes 103, 106 may involve transmitting data to other nodes of the network, such as to other processing devices and/or to client devices. Data may flow through the network of nodes and interconnect devices using one or more protocols such as transmission control protocol (TCP), user datagram protocol (UDP), or Internet protocol (IP), for example. Each interconnect device or interconnect management device 100 may, upon receiving data from a node 103, 106 or another interconnect management device 100, examine the data to identify a destination for the data and route the data through the network.

Client devices as described herein may be computing devices which, for example, engage in AI-related, research-related, and other processor-intensive tasks, and utilize processing devices to handle the computational loads and data throughput required by such intensive applications. Client devices may include, for example, workstations and personal computers used by researchers, data scientists, and professionals for developing, testing, and running AI models and research simulations. Client devices may include one or more CPUs and/or GPUs but may require additional computational power for complex tasks.

By interacting with processing devices, client devices may be enabled to perform functions such as training machine learning models, performing data processing, running simulations, analyzing large datasets, and performing complex data processing tasks, such as data mining, pattern recognition, and predictive modeling, for examples.

As will be described herein, the interconnect management device 100 and/or nodes 103, 106 may be provided with functionality that enable the nodes 103, 106 to apply power saving protocols when the communication link between the nodes 103, 106 is determined to be in a link idle state. The determination that the communication link is about to enter or has entered such a state may be made by the interconnect management device 100, the first node 103, and/or the second node 106. Upon making such a determination with respect to the communication link, the nodes 103, 106 may synchronize with one another to disable at least a part of their encoding and/or decoding functionality. The nodes 103, 106 may remain in such a state until the communication link exists or begins to exit the link idle state.

The functionality responsible for managing the power of the nodes 103, 106 may be provided in the interconnect management device 100, in the first node 103, in the second node 106, or in a combination of the devices 100, 103, 106. With reference now to FIG. 2, additional details of a device 200 will be described in accordance with at least some embodiments of the present disclosure. The device 200 may correspond to the interconnect management device 100, the first node 103, or the second node 106. In other words, the components of the device 200 depicted in FIG. 2 may be incorporated into any one of the interconnect management device 100, the first node 103, or the second node 106 without departing from the present disclosure.

The device 200 is shown to include a plurality of ports 203, routing circuitry 206, processing circuitry 209, and memory 212. The ports 203 of device 200 may be capable of facilitating the transmission of data packets, or non-packetized data, into, out of, and through the device 200. Such ports 203 may serve as interface points where network cables may be connected, connecting the device 200 with other devices 200 (e.g., interconnect management device(s) 100, nodes 103, 106, and other nodes.

Each port 203 may be capable of receiving incoming data packets from other devices and/or transmitting outgoing data packets to other devices. In some implementations, ports 203 may be configured to operate as either dedicated ingress or egress ports 203 or may be enabled to operate in a dual functionality capable of performing ingress and egress functions. For example, an egress port 203 may be used exclusively for sending data from the device 200 and an ingress port 203 may be used solely for receiving incoming data into the device 200.

As referenced above, using a system or method as described herein, links may be opened when traffic is expected to arrive and power consumption associated therewith may be managed when the links enter an idle state. Routing circuitry 206 of device 200 may be capable of handling a received packet by determining an egress port 203b from which to send the packet and forwarding the packet from the determined egress port 203b. Using a system or method as described herein, routing circuitry 206 may be capable of dynamically entering and/or exiting ports 203. As a result, the routing circuitry 206 may be capable of reducing an overall amount of power consumed by the device 200 without incurring a significant penalty in latency.

The routing circuitry 206 of the device 200 may include one or more ingress circuits 215 and egress circuits 218 as described in greater detail below. Each ingress port 203a may be associated with one or more ingress circuits 215 and each egress port 203b may be associated with one or more egress circuits 218. In some implementations, a single port 203 may be capable of acting as both an ingress port 203a and an egress port 203b. In such implementations, the port 203 may be associated with both one or more ingress circuits 215 and one or more egress circuits 218. Each ingress circuit 215 may be associated with an ingress port 203a and each egress circuit 218 may be associated with an egress port 203b.

In support of the functionality of the routing circuitry 206, processing circuitry 209 may be configured to control aspects of power consumption by the device 200. In some embodiments, the power saving functions of the device 200 may be facilitated by the processing circuitry 209 implementing one or more instructions stored in memory 212 as power management instructions 230. The power management instructions 230, when executed by the processing circuitry 209, may configure the processing circuitry 209 to implement certain power saving features, particularly in response to determining that a communication link is in a link idle state. The power management instructions 230 may enable the device 200 to identify when a communication link has entered or is about to enter a link idle state. The power management instructions 230 may alternatively or additionally notify other devices 200 that a communication link is entering or is about to enter a link idle state. The power management instructions 230 may alternatively or additionally cause the device 200 to disable at least a portion of its encoding and/or decoding functionality (e.g., disable part of an encoding operation) in response to determining that a communication link with which the device 200 is associated has entered or is about to enter a link idle state. The power management instructions 230 may alternatively or additionally cause the device 200 to coordinate with other partner nodes while the communication link is in the idle state. While the power management instructions 230 are shown as being stored in memory 212, it should be appreciated that the processing circuitry 209 may comprise one or more hardware elements that implement some or all of the power management functionality. In other words, the power management functionality of the device 200 may be implemented using power management instructions 230 executed by the processing circuitry 209 or the power management functionality of the device 200 may be implemented by specially-configured processing circuitry 209. The processing circuitry 209 may in some implementations include a CPU, an ASIC, and/or other circuit(s) which may be capable of handling computations, decision-making, and management functions required for operation of the device 200.

Processing circuitry 209 may be configured to handle level management and control functions of the device 200, such as setting up routing tables, configuring ports, and otherwise managing operation of the device 200. Processing circuitry 209 may execute software and/or firmware to configure and manage the device 200, such as an operating system and management tools.

Routing circuitry 206 may include one or more circuits and components such as ingress circuits 215, egress circuits 218, queuing circuits 221, shared buffer circuits 224, and/or other circuits and components which may be used to process and forward packets received by the device 200. Each of these examples and others may be as described in greater detail below and may be capable of being selectively enabled and disabled, in whole or in part, based on a status of a communication link with which the device 200 is associated.

Memory 212 of a device 200 as described herein may comprise one or more memory elements capable of storing configuration settings, application data, operating system data, and other data. Such memory elements may include, for example, random access memory (RAM), dynamic RAM (DRAM), flash memory, non-volatile RAM (NVRAM), ternary content-addressable memory (TCAM), static RAM (SRAM), and/or memory elements of other formats.

Memory 212 may store one or more caches 227. Each cache 227 may include a number of entries and may be associated with a particular port 203 of the device 200. As described below, each cache 227 may store data identifying one or more egress ports 203 from which data received at the port 203 associated with the cache 227 is transmitted.

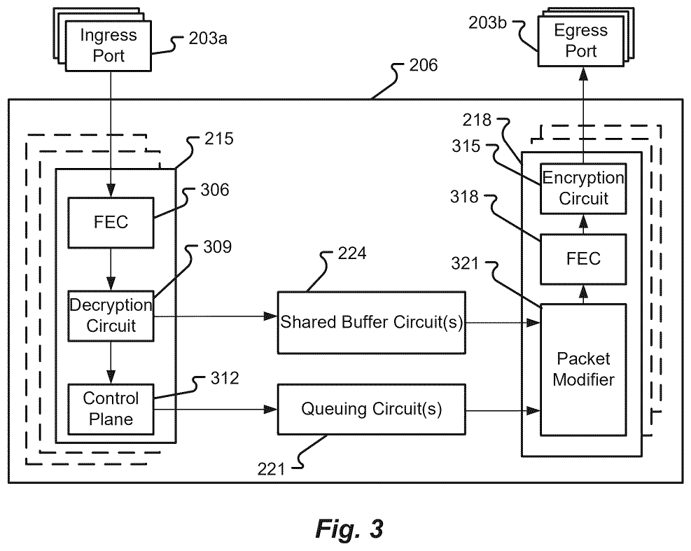

FIG. 3 illustrates elements of routing circuitry 206 of a device 200 in accordance with one or more implementations of the present disclosure. One or more ingress ports 203a may, upon receiving data, transmit the data to one or more ingress circuit 215. In some implementations, each ingress port 203a may be associated with a dedicated ingress circuit 215, while in other implementations, multiple ingress ports 203b may share an ingress circuit 215.

Each ingress circuit 215 may include one or more of a forward error correction (FEC) circuit 306, a decryption circuit 309, a control plane 312, and/or other circuits and components which may handle ingress packets and/or non-packetized ingress data. An FEC circuit 306 as described herein may be used to perform error detection and correction for packets received from an ingress port 203a before the packets are directed to an egress port 203b. The FEC circuit 306 may receive ingress data from an ingress port 203a and, after performing FEC, output the received ingress data or a processed version of the ingress data to a decryption circuit 309.

A decryption circuit 309 as described herein may be used to decrypt all or a portion of received packets to enable the device 200 to determine an egress port 203b from which to send each packet. The decryption circuit 309 may be capable of ensuring that sensitive data remains protected from unauthorized access during traversal of the data through the device 200. The decryption circuit 309 may output received packets or data associated with received packets to one or more shared buffer circuits 224 as described below. The decryption circuit 309 may also output data associated with received packets to the control plane 312.

A control plane 312 as described herein may be used to manage how received data packets are forwarded and handled within the device 200. The control plane 312 may receive data associated with a received packet from the decryption circuit 309 and, based on the data associated with received packet, write instructions to one or more queueing circuits 221 as described below.

A control plane 312 may include one or more components such as one or more RAM circuits, ASICs, FPGAs, flash memory, network interface cards (NICs), content addressable memory (CAM) circuits, port logic circuits, serializer/deserializer (SerDes) circuits, and clock tree circuits, for example. Each component of the control plane 312 may be capable of being selectively enabled and/or disabled based on packets received by the device 200. The control plane 312 may be referred to herein as an ingress control plane. Different packets handled by the device 200 may require a different set or subset of components of the control plane 312 to be forwarded. As described herein, a controller or control circuit may be used which determines which components are required for a received packet and ensures the required components are enabled.

Each of the FEC circuit 306, decryption circuit 309, control plane 312, and/or other circuits and components of the ingress circuits 215 may include one or more of an ASIC, FPGA, digital signal processor (DSP), network processor, accelerator, hardware secure module, CPU, and/or other components and circuits capable of performing ingress processing. As should be appreciated, each ingress circuit 215 of an device 200 may include one or more additional circuits and components in addition to or instead of the FEC circuit 306, decryption circuit 309, and control plane 312 described above.

Each of the ingress circuits 215 of the device 200 may be enabled to write data to a shared-buffer circuit 224 and a queueing circuit 221. Packets to be egressed from the device 200 may be stored in the shared-buffer circuit 224. Data which may be used by egress circuits 218 to route packets to egress ports 203b may be written to the queuing circuits 221. Once a queueing circuit 221 assigns a particular packet to a particular egress port 203b, packet data stored in the shared buffer circuit 224 may be read by an egress circuit 218 associated with the particular egress port 203b.

Data to be sent from the device 200 may be processed by one or more egress circuits 218. In some implementations, each port 203b used for egress may be associated with a dedicated egress circuit 218. In other implementations, multiple egress ports 203b may share one or more egress circuits 218.

An egress circuit 218 may include, but should not be considered as limited to, a packet modifier 321, and FEC 318, and an encryption circuit 315. The FEC 318 and encryption circuit 315 may be configured to perform FEC encoding and encryption functions, respectively. As discussed herein, functionality of the FEC decoder 306 and/or FEC encoder 318 may be selectively enabled and/or disabled based upon a state of a communication link with which the device 200 is associated.

A packet modifier 321 as described herein may include circuitry such as one or more RAM circuits, ASICs, FPGAs, flash memory, NICs, CAM circuits, port logic circuits, SerDes circuits, and clock tree circuits, or other componentry capable of adjusting packets before the packets are transmitted from the interconnect device. Such adjustments may include, for example, the adding or removal of tags, modification of settings and packet header data, and other modifications.

Each component of the packet modifier 321 may be capable of being selectively enabled and/or disabled based on packets received by the device 200. The packet modifier 321 may be referred to herein as an egress control plane. Different packets handled by the device 200 may require a different set or subset of components of the packet modifier 321 to be forwarded.

An encryption circuit 315 and/or FEC encoder 318 as described herein may include circuitry such as an ASIC, an FPGA, or other componentry capable of encrypting packets and encoding packets before the packets are transmitted from the device 200. Such encryption may include, for example, use of encryption algorithms such as Advanced Encryption Standard (AES), RSA, or other algorithms.

After being processed by an egress circuit 218, a packet may be transmitted from the device 200 via an egress port 203b. The egress port 203b may be directly connected to an ultimate destination of the packet or may be connected to another device 200 which may forward the packet towards the ultimate destination.

The reduction of the overall power consumption of the device 200 may be achieved through the selective enabling and disabling of components of ingress circuits 215 and egress circuits 218. As an example, the FEC decoder 306 and/or FEC encoder 318 may be selectively disabled in response to determining that a communication link with which the device 200 is associated has entered or is about to enter a link idle state.

When data is forwarded from the device 200, the processing circuitry 209 be capable of identifying the ingress port 203a at which the data was received and the egress port 203b from which the data was transmitted. The processing circuitry 209 may write data identifying the egress port 203b in a cache 227 associated with the ingress port 203a in memory 212. In this way, each cache 227 may keep a log of recent egress ports 203b used by an ingress port 203a associated with the respective cache 227.

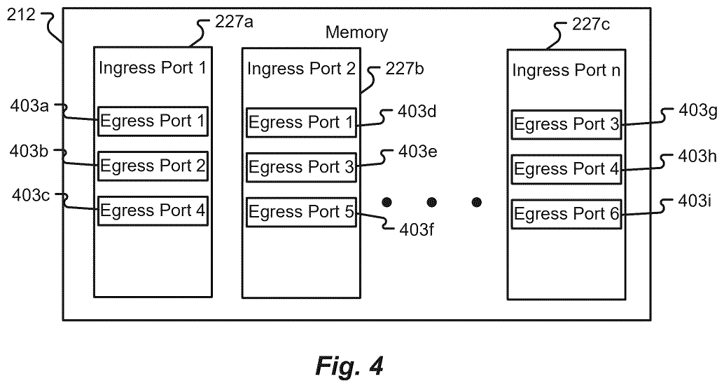

FIG. 4 is an illustration of memory 212 storing a number of caches 227a-c. A first cache 227a is illustrated as being associated with an ingress port 1, a second cache 227b is illustrated as being associated with an ingress port 2, and an nth cache 227c is illustrated as being associated with an ingress port n. While the caches 227a-c of FIG. 4 are each illustrated as being associated with a single ingress port 203a, it should be appreciated that in some implementations other arrangements may be deployed. For example, one cache 227 may be associated with a group of ports 203.

Each cache 227a-c may store identifications 403a-i of egress ports 203b. In the example illustrated in FIG. 4, the cache 227a associated with ingress port 1 includes identifications 403a-c of egress ports 1, 2, and 4, the cache 227b associated with ingress port 2 includes identifications 403d-f of egress ports 1, 3, and 5, and the cache 227c associated with ingress port n includes identifications 403g-i of egress ports 3, 4, and 6. The specific numbers of the egress ports 203b identified in each cache 227a-c should be considered as being included for illustration purposes only and should not be considered as limiting in any way.

Egress ports 203b may be represented in the caches 227 in a number of ways in various implementations. As an example, each port 203b may be represented by a port number or by a bit of a binary number. When a processing circuitry detects an ingress port 203a has received data which was or will be transmitted by a particular egress port 203b, the processing circuitry may edit the cache 227 associated with the ingress port to include an identification of the egress port 203b.

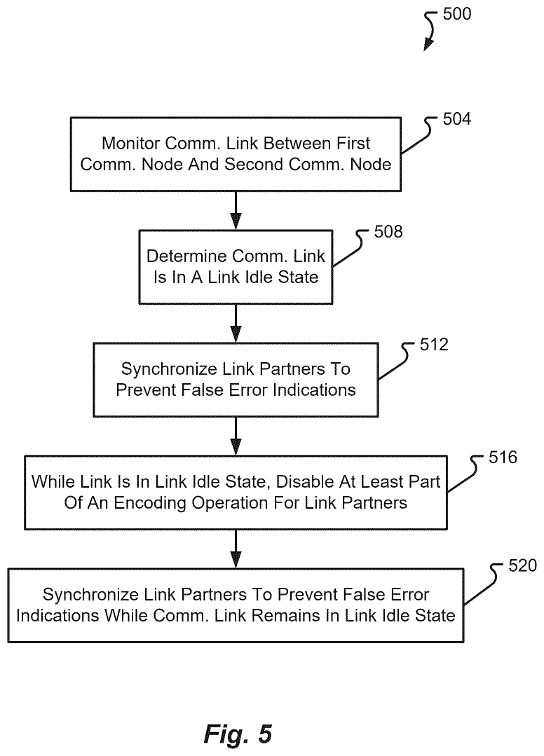

Referring now to FIGS. 5-7, various methods will be described in accordance with at least some embodiments of the present disclosure. The various methods may be performed by one, some, or all components of a computing network. In some embodiments, steps of a method may be performed in the order depicted or in a different order. In some embodiments, steps of one method may be combined with steps of another method. Furthermore, steps of a method may be performed by a single device (e.g., an interconnect management device 100, a node 103, 106, and/or a device 200). Thus, embodiments of the present disclosure contemplate that a method may be performed at a single device of the computing network or may be performed by a plurality of devices.

Referring initially to FIG. 5, a first method 500 will be described in accordance with at least some embodiments of the present disclosure. The method 500 may be implemented by a device 200, such as an interconnect management device 100, a first node 103, and/or a second node 106 to support power saving functionality of the device(s).

The method 500 begins with a device 200 monitoring a communication link between a first node 103 and a second node 106 (step 504). In some embodiments, the communication link subject to monitoring may correspond to a direct communication link 109 between the first node 103 and second node 106. In some embodiments, the communication link subject to monitoring may correspond to a communication link that passes through an interconnect device (e.g., a switch) to support communications between the first node 103 and the second node 106. The communication link may be monitored by an interconnect management device 100, the first node 103, and/or the second node 106. In some embodiments, the communication link may be monitored by the interconnect device that is used to connect the first node 103 and the second node 106. In some embodiments, the interconnect management device 100 may determine the state of the communication link by monitoring the communication link whereas the first node 103 and/or second node 106 determine the state of the communication link based on receiving a state update from the interconnect management device 100.

The method 500 continues by determining that the communication link has entered or is about to enter a link idle state (step 508). The determination of step 508 may be made by the same device that is monitoring the communication link in step 504. The determination that a communication link has entered or is about to enter the link idle state may be based on determining that no packets are traversing the communication link or that buffer circuit(s) 224 or cache(s) 227 associated with the communication link are empty or about to become empty.

In response to determining that the communication link has entered or is about to enter the link idle state, the method 500 continues by synchronizing the link partners (e.g., the first node 103 and second node 106) associated with the communication link to ensure that the prevention of false error indications (step 512). In some embodiments, the first node 103 and second node 106 may synchronize their power saving functions with one another while the communication link is in the link idle state. Synchronizing the power saving functions of the nodes 103, 106 helps to ensure that the communication link is not left in an unsecure state when packets containing data are transmitted across the communication link.

The first node 103 may correspond to a transmitter node and the second node 106 may correspond to a receiving node. In such an embodiment, the communication link may correspond to a unidirectional communication link supporting packet transmissions from the first node 103 to the second node 106. Synchronization between the first node 103 and the second node 106 may be supported by the first node 103 transmitting one or more disable commands to the second node 106 prior to or simultaneous with the first node 103 disabling at least some of its FEC encoding functionality. The disable command(s) transmitted from the first node 103 to the second node 106 may instruct the second node 106 to disable at least some of its FEC decoding functionality. The disable command(s) communicated between the nodes 103, 106 may be communicated in an inband communication. Utilization of an inband communication may support communications of such commands even when the communication link is in a idle state. As will be discussed in further detail herein, the timing with which the disable command(s) is transmitted may help support the synchronization of the nodes 103, 106.

The method 500 may continue with disabling at least part of an encoding operation for the link partners while the communication link is in the link idle state (step 516). As discussed herein, disabling at least part of an encoding operation may include disabling at least some FEC encoding and/or FEC decoding functions of the first node 103 and/or second node 106.

The method 500 may further continue by synchronizing the link partners while the communication link remains in the link idle state (step 520). The synchronization of the link partners may be performed to help prevent false error indications while the communication link is in the link idle state. The synchronization may relate to both link partners agreeing to disable at least a part of their FEC encoding and/or decoding functionality while the communication link is in the link idle state.

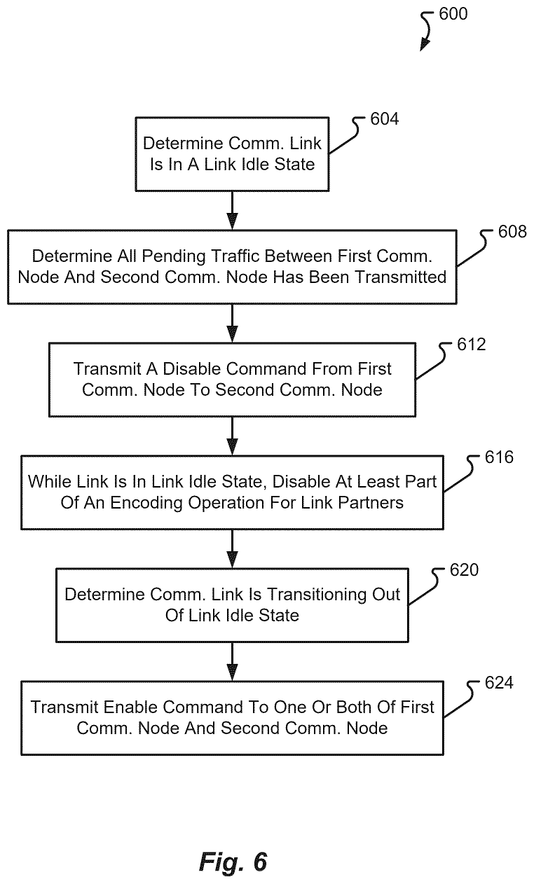

Referring now to FIG. 6, a second method 600 will be described in accordance with at least some embodiments of the present disclosure. The method 600 may include one or more steps to support synchronization of the link partners while the communication link is in the link idle state. The method 600 begins by determining that a communication link is in an idle state (step 604). The communication link may support communications between link partners, which may include the first node 103 and second node 106. The communication link, in some embodiments, may correspond to a unidirectional communication link. The determination of step 604 may be similar or identical to the determination in step 508.

The method 600 may continue by determining that pending traffic between the first node and the second node 106 has been terminated (step 608). Specifically, but without limitation, the first node 103 (e.g., the transmitter node) may determine that its buffer 224 or cache 227 used to transmit data to the second node 106 is about to become empty or is empty. Such a determination may also correspond to a determination (or inference) that the communication link is empty or is about to become empty.

In response to determining that all pending traffic between the first node 103 and second node 106 has been transmitted, the first node 103 may transmit a disable command to the second node 106 (step 612). The disable command may be included in an inband communication established between the first node 103 and second node 106. The disable command may cause the second node 106 (e.g., the receiving node) to disable a decoding operation for the communication link (step 616). In some embodiments, the first node 103 may synchronize disablement of its encoding operation to align with the second node 106 disabling its decoding operation.

The method 600 may continue in response to determining that the communication link is transitioning out of the link idle state (step 620). In some embodiments, the determination of step 620 may be made by the interconnect management device 100. In some embodiments, the determination of step 620 may be made by the first node 103 in response to receiving new data or packets to be transmitted to the second node 106.

In response to determining that the communication link is transitioning out of the link idle state, an enable command may be transmitted to one or both of the first node 103 and second node 106 (step 624). The enable command, in some embodiments, may cause a recipient thereof to enable the part of the encoding operation that was previously discontinued as part of implementing the power-saving functions described herein. In some embodiments, the enable command may be transmitted from the interconnect management device 100 to both the first node 103 and second node 106. In some embodiments, the enable command may be transmitted from the first node 103 to the second node 106. In some embodiments, the enable command may be transmitted from the interconnect management device 100 to the first node 103, then the first node 103 may transmit a second enable command to the second node 106. The enable command may specify a number of blocks that will be transmitted by the first node 103 prior to the first node enabling the encoding operation(s) for data transmissions over the communication link. Synchronization between the nodes 103, 106 may be possible because the communication link may remain in an active, but idle state, even while part of the encoding operations for the communication link are disabled. In some embodiments, the enable command is transmitted from the first node 103 to the second node 106. In some embodiments, the enable command is transmitted from the interconnect management device 100 to the second node 106. In some embodiments, the enable command is transmitted from the interconnect management device 100 to both the first node 103 and the second node 106. In some embodiments, the interconnect management device 100 transmits an enable command to the first node 103, which causes the first node 103 to transmit another enable command to the second node 106.

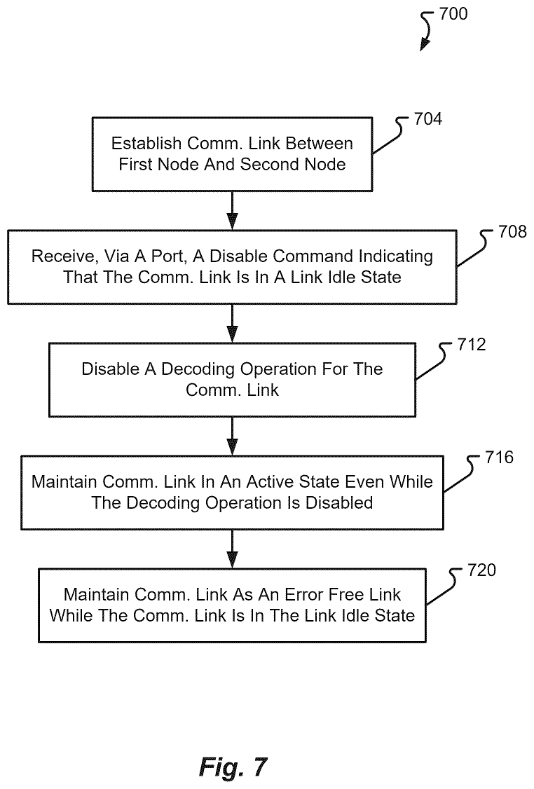

Referring now to FIG. 7, details of another method 700 will be described in accordance with at least some embodiments of the present disclosure. The method 700 may begin when a communication link is established between a first node 103 and a second node 106 (step 704). The communication link may directly connect the first node 103 and second node 106 or may pass through one or more interconnect devices or interconnect management devices 100. The communication link may correspond to a bidirectional communication link or a unidirectional communication link.

The method 700 continues by receiving, at a port 203 supporting the communication link, a disable command indicating that the communication link is in an idle state or is about to enter an idle state (step 708). In some embodiments, the disable command may be received at a receiving node (e.g., a second node 106).

The method 700 may further continue with the recipient of the disable command disabling a decoding operation for the communication link (step 712). In some embodiments, the recipient of the disable command may disable its FEC decoder for communications involving the communication link while the communication link is in the idle state.

The communication link may remain in an active state even while the decoding operation for the communication link is disabled (step 716). Additionally, the communication link may be maintained as an error free link while the communication link is in the idle state (step 720). In some embodiments, the decoding operation may be disabled for as long as the communication link is in the idle state.

The present disclosure encompasses methods with fewer than all of the steps identified in FIGS. 5 through 7 (and the corresponding descriptions of the methods 500, 600, and 700), as well as methods that include additional steps beyond those identified in FIGS. 5 through 7 (and the corresponding description of the methods 500, 600, and 700). The present disclosure also encompasses methods that comprise one or more steps from the methods described herein, and one or more steps from any other method described herein.

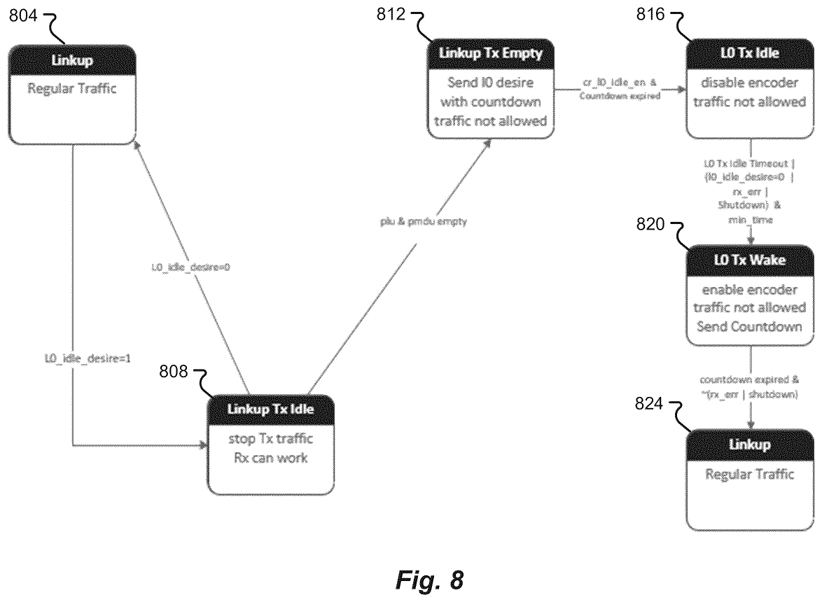

Referring now to FIG. 8, additional details of the possible states that a node 103, 106 will be described in accordance with at least some embodiments of the present disclosure. The states illustrated in FIG. 8 may include states associated with a transmitter node. A first state 804 may correspond to a linkup state where the transmitter node is connected with a receiving node via a communication link and at least some data is being transferred between the nodes via the communication link. The transmitter node may remain in the first state 804 unless and until it is determined that the communication link has entered or is about to enter the idle state (e.g., an L0 idle state).

In response to the communication link entering the idle state, the transmitter node may transition to a second state 808. In the second state, the transmitter node may stop transmitting packets or data traffic on the communication link. From the second state 808, the transmitter node may transition back to the first state 804 if the communication link is no longer idle. While the transmitter node is in the second state 808, the receiving node may remain in a normal operational state.

The transmitter node may also transition from the second state 808 to a third state 812 when the communication has become empty (e.g., no additional blocks or data are being transmitted on the communication link). In the third state 812, the transmitter node may send a command to the receiving node indicating a desire to disable encoding/decoding operations for the communication link. The command may include a disable command as described herein that includes a countdown for the devices to synchronize when their respective encoding/decoding functions will be disabled.

The transmitter node may transition from the third state 812 into the fourth state 816 when the countdown associated with the synchronization counter has expired. In the fourth state 816, the transmitter node is no longer transmitting data or packets to the receiving node over the communication link and encoding/decoding operations associated with the communication link have been disabled.

The transmitter node may then transition to a fifth state 820 in response to an idle timer reaching its maximum value (e.g., or timing out). Alternatively or additionally, the transmitter node may transition to the fifth state 820 in response to determining that data is to be transmitted on the communication link. The fifth state 820 may correspond to a waking state in which the transmitter node begins the process of waking up and re-activating the encoding/decoding functionality for the communication link. In this waking state, the transmitter node may send the receiving node an enable command that specifies a number of blocks that will be transmitted prior to enabling the encoding operation for the communication link. The enable command may cause the receiver node to enable its decoding operations after the specified number of blocks have been received from the transmitter node.

The transmitter node may then transition to a sixth state 824 after the specified number of blocks have been transmitted. In the sixth state 824, a full linkup between the transmitter node and receiving node is achieved and encoding/decoding operations are resumed for the communication link.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art. It is to be appreciated that any feature described herein can be claimed in combination with any other feature(s) as described herein, regardless of whether the features come from the same described embodiment.

What is claimed is:

1. A device comprising one or more circuits to:
determine that a communication link between a first communication node and a second communication node is in a link idle state; and
in response to determining that the communication link is in the link idle state, transmit a disable command to one or both of the first communication node and the second communication node, wherein the disable command causes a recipient thereof to disable part of an encoding operation for the communication link.

2. The device of claim 1, wherein the communication link is determined to be in the link idle state in response to receiving a state update from a power management controller.

3. The device of claim 1, wherein the first communication node comprises a transmitter node, wherein the second communication node comprises a receiver node, and wherein communications between the first communication node and the second communication node are unidirectional.

4. The device of claim 3, wherein the transmitter node transmits the disable command to the receiver node in response to the transmitter node determining that the communication link is in the link idle state.

5. The device of claim 4, wherein the one or more circuits are further to:
determine all pending traffic between the first communication node and the second communication node has been transmitted such that the communication link is empty; and
after determining that the communication link is in the link idle state and is empty, transmit the disable command from the transmitter node to the receiver node.

6. The device of claim 1, wherein the part of the encoding operation comprises an error correction decoding.

7. The device of claim 1, wherein the encoding operation comprises at least one of a Forward Error Correction (FEC) coding and a FEC decoding.

8. The device of claim 1, wherein the part of the encoding operation comprises an error correction encoding.

9. The device of claim 1, wherein the one or more circuits are further to:
determine the communication link is transitioning out of the link idle state; and
in response to determining that the communication link is transitioning out of the link idle state, transmit an enable command to one or both of the first communication node and the second communication node, wherein the enable command causes the recipient thereof to enable the part of the encoding operation for the communication link that was discontinued in response to receiving the disable command.

10. The device of claim 9, wherein the enable command specifies a number of blocks that will be transmitted prior to enabling the encoding operation for the communication link.

11. The device of claim 1, wherein the communication link remains in an active state even while the part of the encoding operation is disabled.

12. The device of claim 1, wherein the disable command is included in an inband communication between both sides of the communication link.

13. The device of claim 1, wherein the communication link is maintained as an error free link while in the link idle state.

14. A communication node, comprising:
a port that facilitates interconnectivity with a communication network; and
one or more circuits to:
establish a communication link with a receiver node via the port;
determine that the communication link is in a link idle state; and
in response to determining that the communication link is in the link idle state, transmit a disable command to the receiver node, wherein the disable command causes the receiver node to disable a decoding operation for the communication link.

15. The communication node of claim 14, wherein the communication link is determined to be in the link idle state in response to receiving a state update from a power management controller.

16. The communication node of claim 14, wherein the one or more circuits are further to:
determine all pending traffic for the receiver node has been transmitted such that the communication link is empty; and
after determining that the communication link is in the link idle state and is empty, transmit the disable command to the receiver node.

17. The communication node of claim 14, wherein the decoding operation comprises an error correction decoding.

18. The communication node of claim 14, wherein the one or more circuits are further to:
determine the communication link is transitioning out of the link idle state; and
in response to determining that the communication link is transitioning out of the link idle state, transmit an enable command to the receiver node that causes the receiver node to enable the decoding operation.

19. The communication node of claim 18, wherein the enable command specifies a number of blocks that will be transmitted prior to enabling an encoding operation for the communication link.

20. A communication node, comprising:
a port that facilitates interconnectivity with a communication network; and
one or more circuits to:
establish a communication link with a transmitter node via the port;
receive, via the port, a disable command indicating that the communication link is in a link idle state; and
in response to receiving the disable command, disable a decoding operation for the communication link.

21. The communication node of claim 20, wherein the communication link remains in an active state even while the decoding operation is disabled, wherein the communication link is unidirectional.
